(19) United States
(12) Patent Application Publication
(10) Pub. No.: US 2025/0266491 A1
(43) Pub. Date: Aug. 21, 2025

(54) Electrode Assembly Insertion Guide and Electrode Assembly Inserting Method Using the Same

(71) Applicant: SK On Co., Ltd., Seoul (KR)

(72) Inventors: Hoemin CHEONG, Daejeon (KR); Hae Ryong JEON, Daejeon (KR); Soo In PARK, Seoul (KR)

(21) Appl. No.: 19/050,242

(22) Filed: Feb. 11, 2025

(30) Foreign Application Priority Data
Feb. 21, 2024 (KR) 10-2024-0025057

(51) Int. Cl. H01M 10/04; H01M 50/477

(52) U.S. Cl. CPC H01M 10/049; H01M 50/477

(57) ABSTRACT

The present disclosure relates to an electrode assembly insertion guide including a body part detachably coupled to an edge of an opening part formed by opening one surface of an accommodation case, and a coupling part formed by recessing one surface of the body part facing the opening part along a direction from an inside of the accommodation case toward the opening part, and an electrode assembly inserting method.

### CROSS-REFERENCE TO RELATED PATENT APPLICATION

The present application claims priority under 35 U.S.C. § 119(a) to Korean patent application number 10-2024-0025057 filed on Feb. 21, 2024, in the Korean Intellectual Property Office, the entire disclosure of which is incorporated by reference herein.

### BACKGROUND OF THE INVENTION

### 1. Field

Embodiments of the present disclosure relate to an electrode assembly insertion guide and an electrode assembly inserting method using the same.

### 2. Description of the Related Art

A secondary battery is a battery which converts electrical energy into chemical energy, stores it, and can be reused multiple times through charging and discharging. Secondary batteries are widely used in various industries due to their economical and eco-friendly characteristics. In particular, a lithium secondary battery among the secondary batteries is widely used in various industries, including portable devices which require high-density energy.

The operating principle of the lithium secondary battery is an electrochemical oxidation-reduction reaction. In other words, the principle is that electricity is generated by movement of lithium ions and charging is done through the reverse process. In the case of the lithium secondary battery, the phenomenon of lithium ions in an anode escaping and moving to a cathode through an electrolyte and a separator is called discharge. And the opposite process of this phenomenon is called charging.

The secondary battery may be manufactured by putting it in an accommodation case to protect an electrode assembly from external shock and heat. When inserting the electrode assembly into the accommodation case, the accommodation case may be damaged or the electrode assembly may be damaged. Therefore, research is actively being conducted on methods to safely insert the electrode assembly into the accommodation case.

### SUMMARY OF THE INVENTION

According to one aspect of the present disclosure, an object is to maximize the performance of a battery cell by preventing damage to an accommodation case or an electrode assembly.

According to another aspect of the present disclosure, an object is to simply and quickly insert the electrode assembly into the accommodation case.

The present disclosure may be widely applied in green technology fields such as electric vehicles, battery charging stations, energy storage systems (ESS), and other photovoltaics and wind power using batteries. In addition, the present disclosure can be used in eco-friendly mobility including electric vehicles and hybrid vehicles for preventing climate change by suppressing air pollution and greenhouse gas emissions.

An electrode assembly insertion guide according to the present disclosure is an electrode assembly insertion guide for guiding insertion of an electrode assembly into an accommodation case, the electrode assembly insertion guide including: a body part detachably coupled to an edge of an opening part formed by opening one surface of the accommodation case; and a coupling part formed by recessing one surface of the body part facing the opening part along a direction from an inside of the accommodation case toward the opening part.

The body part may include a first support part which is extended in a direction opposite to the direction in which the coupling part is recessed and to contact an inner surface of the accommodation case; and a second support part which is extended in the direction opposite to the direction in which the coupling part is recessed to contact an outer surface of the accommodation case.

The first support part and the second support part may be formed side by side.

A length from a coupling surface where the coupling part is in contact with one end of the edge to one end of the first support part may be greater than or equal to a length from the coupling surface to one end of the second support part.

A thickness of the first support part along a direction from an inside of the accommodation case toward an outside of the accommodation case may be less than or equal to a thickness of the accommodation case.

A plurality of the body parts may be provided, and the plurality of body parts may be coupled at different locations of the edge of the opening part.

The body part may have a frame shape.

The electrode assembly insertion guide may include an inclined surface formed to be inclined at another end opposite to one end at which the coupling part is formed.

The inclined surface may be located to face the inside of the accommodation case.

The inclined surface may be formed in a direction away from the inside of the accommodation case along the direction from the inside of the accommodation case toward the opening part.

The electrode assembly insertion guide may further include a groove part formed by recessing a surface facing the inside of the accommodation case among surfaces of the body part in a direction toward the outside.

The groove part may be extended along the direction from the inside of the accommodation case toward the opening part.

A plurality of the groove parts may be provided.

The plurality of groove parts may be located to be spaced apart from each other in a direction perpendicular to the direction from the inside of the accommodation case toward the opening part.

An electrode assembly inserting method of the present disclosure is an electrode assembly inserting method using an electrode assembly insertion guide for guiding insertion of an electrode assembly into an accommodation case, the method including: coupling a body part to an edge of an opening part formed by opening one surface of the accommodation case; and inserting the electrode assembly into the accommodation case through the opening part.

The method of the present disclosure may further include separating the body part coupled to the edge of the opening part from the accommodation case.

According to an embodiment of the present disclosure, it is possible to maximize the performance of a battery cell by preventing damage to an accommodation case or an electrode assembly.

According to another embodiment of the present disclosure, it is possible to simply and quickly insert the electrode assembly into the accommodation case.

### BRIEF DESCRIPTION OF THE DRAWINGS

FIG. 1 illustrates an electrode assembly being inserted into an accommodation case according to an embodiment of the present disclosure.

FIG. 2 illustrates an electrode assembly insertion guide being coupled to an accommodation case according to an embodiment of the present disclosure.

FIG. 3 illustrates an electrode assembly insertion guide being coupled to an accommodation case according to another embodiment of the present disclosure.

FIGS. 4 and 5 illustrate an electrode assembly insertion guide being coupled to an accommodation case along line AA′ of FIG. 2.

FIG. 6 illustrates a cross-section of an accommodation case and an electrode assembly insertion guide coupled according to an embodiment of the present disclosure.

FIG. 7 illustrates a cross-section of an accommodation case and an electrode assembly insertion guide coupled according to another embodiment of the present disclosure.

FIG. 8 illustrates an electrode assembly inserting method according to an embodiment of the present disclosure.

### DETAILED DESCRIPTION

Hereinafter, the present disclosure will be described in detail with reference to the accompanying drawings. However, this is merely exemplary and the present disclosure is not limited to specific embodiments described by way of example.

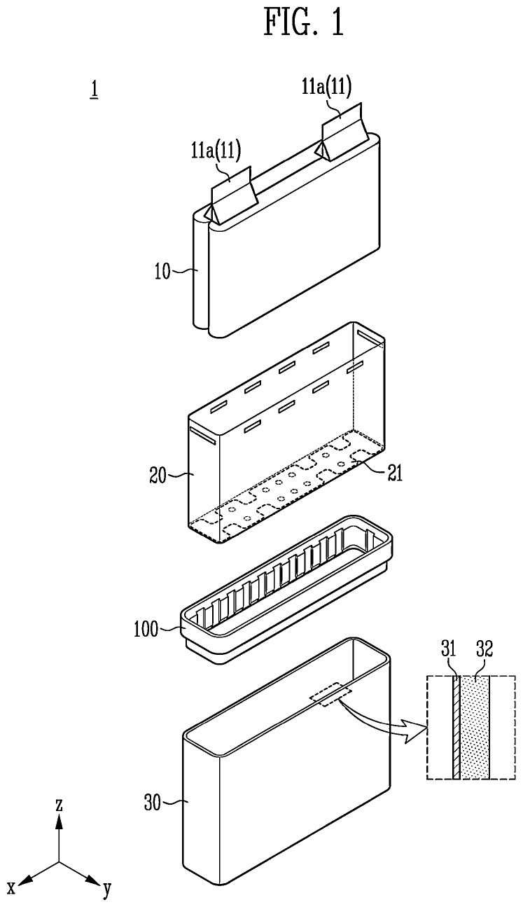

FIG. 1 illustrates an electrode assembly 10 being inserted into an accommodation case 30 according to an embodiment of the present disclosure.

Referring to FIG. 1, an electrode assembly insertion guide 100 of the present disclosure may guide the insertion of the electrode assembly 10 into the accommodation case 30.

Guiding the insertion of the electrode assembly 10 may refer to guiding the path of the electrode assembly 10 so that the electrode assembly 10 may be easily inserted into the accommodation case 30. Alternatively, it may mean that after a portion of the electrode assembly 10 is inserted into the electrode assembly insertion guide 100, when pressure is applied to the electrode assembly 10, the electrode assembly 10 moves in a direction preset by the electrode assembly insertion guide 100.

The electrode assembly 10 of the present disclosure may be inserted into the accommodation case 30 and supply electric energy to the outside through charging and discharging. To this end, the electrode assembly 10 may include a cathode and an anode. Charging and discharging may occur as lithium ions are oxidized or reduced at the cathode and anode.

The cathode and the anode may include a current collector. The cathode may include a cathode current collector, and the anode may include an anode current collector. The current collector may include a known conductive material within a range that does not cause a chemical reaction within a lithium secondary battery.

For example, the current collector may include any one of stainless steel, nickel (Ni), aluminum (Al), titanium (Ti), copper (Cu), and alloys thereof, and may be provided in various forms, such as a film, a sheet, and a foil.

The cathode and the anode may further include an active material. The cathode may include a cathode active material, and the anode may include an anode active material. The cathode active material and the anode active material may be materials into which lithium ions may be inserted and detached, respectively.

For example, the cathode active material may be lithium metal oxide, and the anode active material may be any one of carbon-based materials such as crystalline carbon, amorphous carbon, carbon composites, and carbon fibers, lithium alloys, silicon (Si), and tin (Sn).

The cathode and the anode may further include a binder and a conductive material, respectively, to improve mechanical stability and electrical conductivity.

The electrode assembly 10 may further include a separator. The separator may be configured to prevent electrical short-circuiting between the cathode and the anode and to allow ion flow. The type of the separator is not particularly limited, but may include a porous polymer film. For example, the separator may include a porous polymer film or a porous non-woven fabric.

The electrode assembly 10 may be classified into a stacking type, a winding type, a stack-folding type, and a Z-stacking type depending on the method in which the cathode, the anode, and the separator are stacked. The stacking method of the electrode assembly 10 of the present disclosure is not limited to any one stacking method.

The electrode assembly 10 may further include a tab part 11. The tab part 11 may include a cathode tab part 11a electrically connected to the cathode. The tab part 11 may include an anode tab part 11b electrically connected to the anode. The cathode tab part 11a may be formed of the same material as the cathode current collector, and the anode tab part 11b may be formed of the same material as the anode current collector.

The tab part 11 may be electrically connected to a terminal (not shown) that is electrically connected to an external device. As a result, the electrode assembly 10 of the present disclosure may be connected to an external device through the tab part 11 and the terminal to supply energy.

As illustrated in FIG. 1, the tab part 11 may be formed side by side with one surface of the electrode assembly 10, but is not limited thereto.

The electrode assembly 10 may be covered by a cover part 20. The cover part 20 may cover an outer surface of the electrode assembly 10. The cover part 20 may be formed of a highly insulating material to improve the insulation of the electrode assembly 10.

In an embodiment, the cover part 20 may be formed to correspond to the shape of the electrode assembly 10. Referring to FIG. 1, the cover part 20 may be provided in a hexahedral shape to correspond to the electrode assembly 10, and the cover part 20 may further include a cover insulation part 21 provided on the inner lower surface to insulate the electrode assembly 10.

The electrode assembly 10 covered by the cover part 20 may be accommodated in the accommodation case 30. The accommodation case 30 may accommodate the electrode assembly 10 and an electrolyte.

The accommodation case 30 may protect the electrode assembly 10 from external impact, pressure, or heat, and maintain the insulation of the electrode assembly 10. To this end, the accommodation case 30 may be formed with a structure in which multiple layers are stacked.

The accommodation case 30 may include a frame part 32 and an insulation part 31. The frame part 32 may include a metal layer. The metal layer may use a material having high mechanical strength to prepare for external impact.

The insulation part 31 may be formed by coating one surface of the frame part 32. Referring to FIG. 1, the insulation part 31 may be coated on one surface of the frame part 32 to insulate the inside and outside of the accommodation case 30.

The accommodation case 30 may include an opening part 33. The opening part 33 may be formed by opening one surface of the accommodation case 30. The electrode assembly 10 may be inserted into the accommodation case 30 through the opening part 33.

In an embodiment, the opening part 33 may be formed at the upper part of the accommodation case 30. The opening part 33 may also be formed at the side part of the accommodation case 30.

In the present specification, the direction from the inside of the accommodation case 30 toward the opening part 33 may refer to a direction parallel to the Z-axis direction. Referring to FIG. 1, the opening part 33 may be formed by opening a surface facing the upper part of the accommodation case 30 along the Z-axis direction.

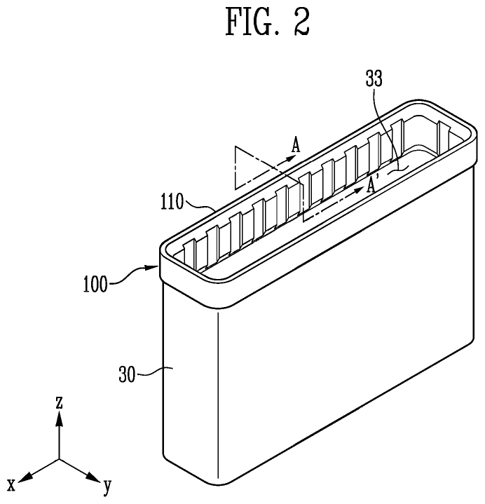

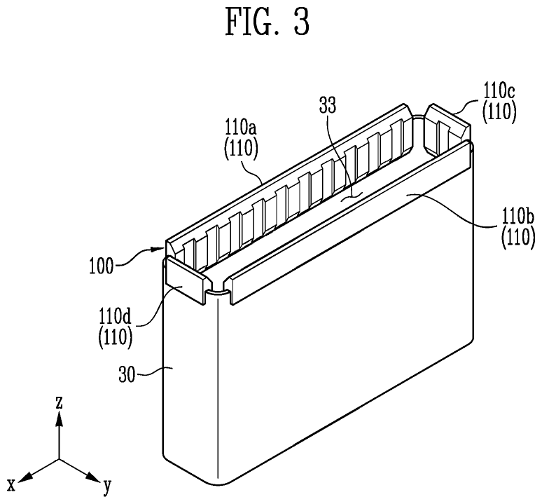

FIG. 2 illustrates an electrode assembly insertion guide 100 being coupled to the accommodation case 30 according to an embodiment of the present disclosure, and FIG. 3 illustrates the electrode assembly insertion guide 100 being coupled to the accommodation case 30 according to another embodiment of the present disclosure.

The electrode assembly 10 may be inserted into the accommodation case 30 through the opening part 33. However, when the electrode assembly 10 is inserted, an edge of the opening part 33 and the electrode assembly 10 may come into unintentional contact.

It is preferable that the electrode assembly 10 be configured to include as many cathodes and anodes as possible in order to increase energy density. Therefore, the electrode assembly 10 may be provided in a size that fills most of the interior of the accommodation case 30.

When the electrode assembly 10 that occupies a large volume is placed inside the accommodation case 30, the edge of the opening part 33 may be pressed by the electrode assembly 10. The edge of the opening part 33 is an end portion of one surface of the accommodation case 30, and referring to FIG. 1, the insulation part 31 may be coated on the frame part 32.

At this time, the coating of the insulation part 31 may be damaged by the electrode assembly 10, and the insulation part 31 may be peeled off. In addition, one area of the electrode assembly 10 may be pressed, and the electrode assembly 10 may be damaged.

The electrode assembly insertion guide 100 of the present disclosure includes a body part 110 which is detachably coupled to the edge of the opening part 33 formed by opening one surface of the accommodation case 30, and a coupling part 120 formed by recessing one surface of the body part 110 facing the opening part 33 along a direction from the inside of the accommodation case 30 toward the opening part 33.

The body part 110 may be detachably coupled to the edge of the opening part 33. The electrode assembly insertion guide 100 is for protecting the accommodation case and guiding the insertion of the electrode assembly 10, and may be attached to the accommodation case 30 when inserting the electrode assembly 10. The electrode assembly insertion guide 100 may be separated from the accommodation case 30 after a portion of the electrode assembly 10 is inserted or the electrode assembly 10 is completely inserted.

Through this, the electrode assembly insertion guide 100 may quickly and safely insert the electrode assembly 10 into the accommodation case 30 without lowering the energy density of the battery cell.

The electrode assembly insertion guide 100 may be coupled with the accommodation case 30 along the edge of the opening part 33. Referring to FIG. 2, the electrode assembly insertion guide 100 may be formed integrally. In other words, the body part 110 may have a frame shape to correspond to the edge of the opening part 33.

For example, the body part 110 may be formed in a rectangular frame shape. If the opening part 33 is provided in an oval or polygonal shape, the body part 110 may also be provided in an oval or polygonal shape.

In an embodiment, referring to FIG. 3, a plurality of the body parts 110 (110a, 110b, 110c, and 110d) may be provided. The plurality of body parts 110a, 110b, 110c, 110d may be coupled at different locations of the accommodation case 30.

In order to assemble the frame-shaped body part 110 with the opening part 33, the opening part 33 and the body part 110 must be positioned so as to correspond, and then pressurized. However, it may be difficult to position them so as to correspond to each other, and even if they correspond, the positions may be misaligned when pressurized. Alternatively, if a part is damaged, assembly may not be easy.

When the plurality of body parts 110 are provided, each of the plurality of body parts 110a, 110b, 110c, and 110d may be coupled to the edge of the opening part 33. After any one body part 110a is coupled to the accommodation case 30, another body part 110b may be coupled to the accommodation case 30.

For example, the body part 110 may be formed to extend in one direction. The body part 110 may be extended in a direction perpendicular to the direction from the inside of the accommodation case 30 toward the opening part 33.

The plurality of body parts 110 may each be coupled to an area excluding the corners of the edge of the opening part 33. Even if the body parts 110 are coupled only to the area excluding the corners, the electrode assembly 10 may be easily inserted into the accommodation case 30.

In another embodiment, the plurality of body parts 110 may be connected to each other to form a frame-shaped body part 110. Thereafter, the frame-shaped body part 110 may be coupled to the edge of the opening part 33.

The coupling part 120 may be formed by recessing one surface of the body part 110 so that the edge of the opening part 33 is inserted. A portion of the edge may be located between the connecting part 120 so that the body part 110 may be stably fixed to the accommodation case 30. The coupling part 120 may be formed to correspond to the shape of the edge of the opening part 33.

The coupling part 120 may be located on the lower surface of the body part 110 along the Z-axis direction. In addition, since the outer surface of the edge of the opening part 33 is formed with three vertical surfaces, the coupling part 120 may also have three vertically connected surfaces.

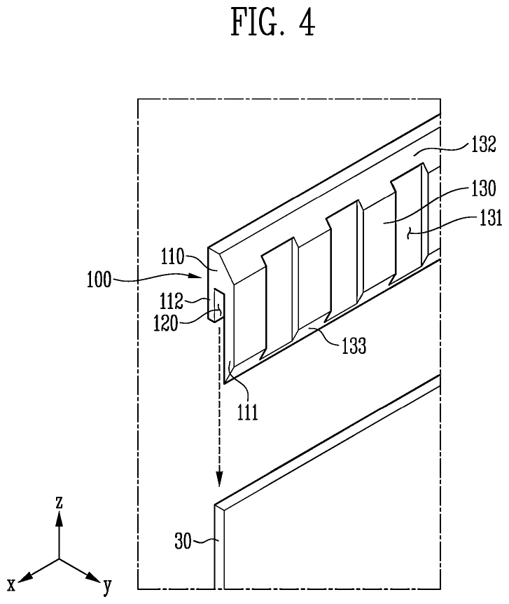

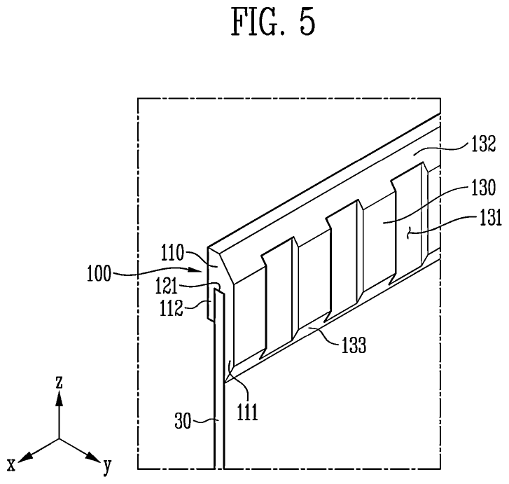

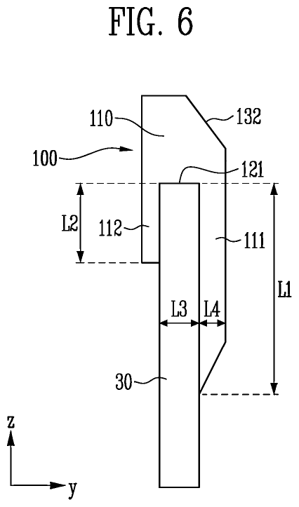

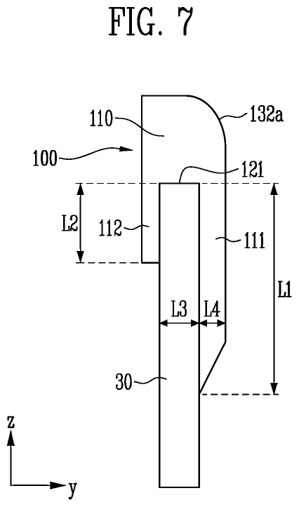

FIGS. 4 and 5 illustrate the electrode assembly insertion guide 100 being coupled to the accommodation case 30 along line AA′ of FIG. 2, FIG. 6 illustrates a cross-section of the accommodation case 30 and the electrode assembly insertion guide 100 coupled according to an embodiment of the present disclosure, and FIG. 7 illustrates a cross-section of the accommodation case 30 and the electrode assembly insertion guide 100 coupled according to another embodiment of the present disclosure.

Referring to FIG. 4, after locating the body part 110 on the edge of the opening part 33, the body part 110 may be moved toward the edge so that the body part 110 may be coupled to the edge. To this end, the coupling part 120 should be provided with a size such that the edge of the opening part 33 may be inserted.

The edge of the opening part 33 may be fit-coupled to the coupling part 120. The edge may be inserted into the coupling part 120 so as to fulfill the space of the coupling part 120. Referring to FIG. 5, the edge and the body part 110 may be fit-coupled by the coupling part 120.

The body part 110 may include a first support part 111 and a second support part 112. The first support part 111 may be extended in a direction opposite to the direction in which the coupling part 120 is recessed to contact with an inner surface of the accommodation case 30. The second support part 112 may be extended in a direction opposite to the direction in which the coupling part 120 is recessed to contact with an outer surface of the accommodation case 30.

The inner surface of the accommodation case 30 means one surface of the accommodation case 30 that faces the electrode assembly 10. The outer surface of the accommodation case 30 means one surface of the accommodation case 30 that is exposed to the outside. In other words, the first support part 111 and the second support part 112 may come into contact with the inner surface and the outer surface of the accommodation case 30, respectively. Through this, even if the body part 110 is pressurized, it may not be separated from the accommodation case 30.

Referring to FIGS. 4 and 5, the first support part 111 and the second support part 112 may each be extended downward from the body part 110 along the Z-axis direction. The first support part 111 and the second support part 112 may be located to be opposite to each other with respect to the coupling part 120.

In other words, the accommodation case 30 may be inserted into the coupling part 120, and the first support part 111 may be located in a direction from the coupling part 120 toward the inside of the accommodation case 30. Conversely, the second support part 112 may be located in a direction from the coupling part 120 toward the outside of the accommodation case 30.

The first support part 111 and the second support part 112 may be formed side by side. The first support part 111 and the second support part 112 may be extended side by side from the body part 110. Through this, the fixing force of the body part 110 may be improved.

Specifically, even if the body part 110 is pressed in a direction from the inside toward the outside of the electrode assembly 10 or pressed in an opposite direction, the body part 110 will not be easily separated by the first support part 111 and the second support part 112.

The length from a coupling surface where the coupling part 120 is in contact with one end of the edge to one end of the first support part 111 may be longer than or equal to the length from the coupling surface to one end of the second support part 112. When the edge is inserted into the coupling part 120, one end of the edge may come into contact with a surface forming the coupling part 120.

Here, the one end of the edge may refer to a surface of the edge facing the coupling part 120. In other words, it may refer to a surface facing upward along the Z-axis direction from the edge. The coupling surface may mean a surface of the coupling part 120 facing one end of the edge. For example, referring to FIG. 5, the coupling surface may mean an upper surface of the coupling part 120.

The length from the coupling surface to one end of the first support part 111 and the length from the coupling surface to one end of the second support part 112 may be measured along a direction parallel to the direction from the inside of the accommodation case 30 toward the opening part 33. Referring to FIG. 6, the length (L1) from the coupling surface to one end of the first support part 111 may be longer than the length (L2) from the coupling surface to one end of the second support part 112.

The first support part 111 is extended long in order to guide the insertion of the electrode assembly 10. When the electrode assembly 10 is pressed after a portion of the electrode assembly 10 is inserted into the body part 110, the electrode assembly 10 may be inserted smoothly. However, when the first support part 111 is formed short, the electrode assembly 10 may not move along a predetermined path.

In other words, when the electrode assembly 10 is not inserted into the body part 110 by a predetermined length, the electrode assembly 10 may be bent or broken by the body part 110 when the electrode assembly 10 is pressed. Therefore, it may be preferable for the body part 110 to be extended by a predetermined length from the inner side of the electrode assembly 10.

The thickness of the first support part 111 in the direction from the inside of the accommodation case 30 toward the outside of the accommodation case 30 may be less than or equal to the thickness of the accommodation case 30. This is to reduce the space occupied by the body part 110.

When the body part 110 is coupled to the edge of the opening part 33, a portion of the body part 110 and the opening part 33 may overlap along the Z-axis direction. An entrance of the opening part 33 is reduced by the area occupied by the body part 110, and ultimately the space into which the electrode assembly 10 can be inserted is reduced. Therefore, it is necessary to minimize the area of the opening part 33 reduced by the body part 110.

To this end, it may be preferable that the thickness of the first support part 111 be provided thin. Referring to FIG. 6, the thickness (L4) of the first support part 111 may be less than or equal to the thickness (L3) of the accommodation case 30.

After the body part 110 is coupled to the edge of the opening part 33, the electrode assembly 10 may come into contact with the body part 110 and be inserted into the accommodation case 30. In order to induce insertion of the electrode assembly 10, one surface of the body part 110 may be formed to be inclined. An inclined surface 132 may be formed at another end opposite to the one end where the coupling part 120 is formed.

The electrode assembly insertion guide 100 of the present disclosure may be fixed to the accommodation case 30 by having an edge inserted into the coupling part 120 formed at one surface of the body part 110. After being fixed, the other end opposite to the one end where the coupling part 120 is formed may come into contact with the electrode assembly 10 to guide insertion of the electrode assembly 10. Therefore, the inclined surface 132 may be provided at another end.

In addition, the inclined surface 132 may be located to face the inside of the accommodation case 30. Since the electrode assembly 10 is inserted into the inside of the accommodation case 30, the inclined surface 132 should be located to face the inside of the accommodation case 30. Referring to FIG. 6, the right side of the accommodation case 30 along the Y-axis direction may refer to the inside of the accommodation case 30, and the left side of the accommodation case 30 may refer to the outside of the accommodation case 30. The inclined surface 132 may be formed on the right side of the body part 110 along the Y-axis direction so as to face the inside of the accommodation case 30.

The inclined surface 132 may be formed in a direction away from the inside of the accommodation case 30 along the direction from the inside of the accommodation case 30 toward the opening part 33. In other words, the inclined surface 132 may be formed so that the area through which the electrode assembly 10 passes becomes narrower as it moves from the outside to the inside of the accommodation case 30. Through this, after one end of the electrode assembly 10 is stably located in the body part 110, it may be pressed and inserted into the inside of the accommodation case 30.

Referring to FIGS. 4 to 6, the inclined surface 132 may move away to the left side along the Y-axis direction as it gets further away from the inside of the accommodation case 30 along the Z-axis direction.

In another embodiment, referring to FIG. 7, the inclined surface 132a may be formed as a curved surface. In other words, the inclination of the inclined surface 132a may gradually change. Similarly, the inclined surface 132a formed as a curved surface may be positioned further to the left side along the Y-axis direction as it gets farther from the inside of the accommodation case 30.

For example, an inclined surface 133 of the body part 110 may also be formed at one end where the coupling part 120 is formed. Referring to FIGS. 5 to 7, the inclined surface 133 may be formed at one end of the first support part 111. The inclined surface 133 may be formed on a surface of the first support part 111 that faces the inside of the accommodation case 30.

The inclined surface 133 of the first support part 111 may form an incline that becomes closer to the inner surface of the accommodation case 30 as it moves toward the inside of the accommodation case 30 from the opening part 33. Through this, the area through which the electrode assembly 10 passes may gradually increase, thereby minimizing damage to the electrode assembly 10.

The electrode assembly insertion guide 100 of the present disclosure may include a groove part 131. The groove part 131 may be formed by recessing a surface facing the inside of the accommodation case 30 among surfaces of the body part 110 in a direction toward the outside.

When the electrode assembly 10 is inserted, the fluid inside the accommodation case 30 may be discharged to the outside through the opening part 33. For example, the fluid may be air. However, since the electrode assembly 10 is inserted through the opening part 33, the air may not be discharged smoothly, which may cause damage to the electrode assembly 10.

The groove part 131 may be formed on a surface where the electrode assembly insertion guide 100 and the electrode assembly 10 meet to allow the air to be discharged to the outside of the accommodation case 30. Referring to FIGS. 4 and 5, the groove part 131 may be formed on a surface of the first support part 111 facing the inside of the accommodation case 30.

The groove part 131 may be extended along the direction from the inside of the accommodation case 30 toward the opening part 33. For example, the groove part 131 may be extended along the Z-axis direction. Through this, the groove part 131 may discharge air to the outside of the accommodation case 30. Even when the first support part 111 and the electrode assembly 10 come into contact, air may be discharged to the outside by the groove part 131.

A plurality of the groove parts 131 may be provided. Air may be efficiently discharged through the plurality of groove parts 131. The plurality of groove parts 131 may be located to be spaced apart from each other in a direction perpendicular to the direction from the inside of the accommodation case 30 toward the opening part 33.

Referring to FIGS. 4 and 5, the plurality of groove parts 131 may be located to be spaced apart from each other along the X-axis direction. Any one groove part 131 may be located to be extended along the Z-axis direction on the first body part 110, and another groove part 131 may be located to be spaced apart from the any one groove part 131 along the X-axis direction.

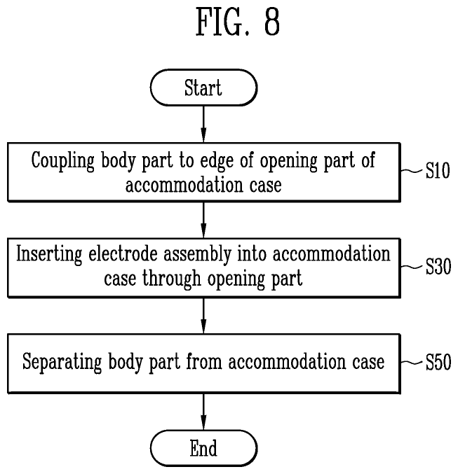

FIG. 8 illustrates an electrode assembly inserting method according to an embodiment of the present disclosure. Hereinafter, with reference to FIG. 8, a method of inserting the electrode assembly 10 (hereinafter, also referred to as an electrode assembly inserting method) using the electrode assembly insertion guide 100 of the present disclosure will be described.

The electrode assembly inserting method of the present disclosure includes coupling the body part 110 to the edge of the opening part 33 formed by opening one surface of the accommodation case 30 (S10), and inserting the electrode assembly 10 into the accommodation case 30 through the opening part 33 (S30).

In the present disclosure, the inserting of the electrode assembly 10 into the accommodation case 30 through the opening part 33 (S30) may be performed after the coupling of the body part 110 to the edge of the opening part 33 (S10).

During inserting the electrode assembly 10 into the accommodation case 30 (S30), the electrode assembly 10 may come into contact with the electrode assembly insertion guide 100. After a portion of the electrode assembly 10 is inserted into the entrance formed by the electrode assembly insertion guide 100, the electrode assembly 10 may be pressed.

After one end of the electrode assembly 10 is inserted by a predetermined length, the present disclosure may perform separating the body part 110 from the accommodation case 30 (S50). In another embodiment, the separating of the body part 110 from the accommodation case 30 (S50) may be performed after the electrode assembly 10 is inserted into the accommodation case 30.

In the present disclosure, when the plurality of body parts 110 are provided, the plurality of body parts 110 may be respectively coupled to the edge of the opening part 33. After the plurality of body parts 110 are coupled, the inserting of the electrode assembly 10 into the accommodation case 30 through the opening part 33 (S30) may be performed.

The present disclosure may be implemented in various forms and is not limited to the scope of the above-described embodiments. The above descriptions are merely examples of applying the principles of the present disclosure, and other configurations may be further included without departing from the scope of the present disclosure.

What is claimed is:

1. An electrode assembly insertion guide for guiding insertion of an electrode assembly into an accommodation case, the electrode assembly insertion guide comprising:
a body part detachably coupled to an edge of an opening part formed by opening one surface of the accommodation case; and
a coupling part formed by recessing one surface of the body part facing the opening part along a direction from an inside of the accommodation case toward the opening part.

2. The electrode assembly insertion guide according to claim 1, wherein the body part comprises:
a first support part which is extended in a direction opposite to the direction in which the coupling part is recessed to contact an inner surface of the accommodation case; and
a second support part which is extended in the direction opposite to the direction in which the coupling part is recessed to contact an outer surface of the accommodation case.

3. The electrode assembly insertion guide according to claim 2, wherein the first support part and the second support part are formed side by side.

4. The electrode assembly insertion guide according to claim 2, wherein a length from a coupling surface where the coupling part is in contact with one end of the edge to one end of the first support part is greater than or equal to a length from the coupling surface to one end of the second support part.

5. The electrode assembly insertion guide according to claim 2, wherein a thickness of the first support part along a direction from the inside of the accommodation case toward an outside of the accommodation case is less than or equal to a thickness of the accommodation case.

6. The electrode assembly insertion guide according to claim 1, wherein a plurality of the body parts are provided, and the plurality of body parts are coupled at different locations of the edge of the opening part.

7. The electrode assembly insertion guide according to claim 1, wherein the body part has a frame shape.

8. The electrode assembly insertion guide according to claim 1, further comprising:
an inclined surface formed to be inclined at another end opposite to one end at which the coupling part is formed.

9. The electrode assembly insertion guide according to claim 8, wherein the inclined surface is located to face the inside of the accommodation case.

10. The electrode assembly insertion guide according to claim 8, wherein
the inclined surface is formed in a direction away from the inside of the accommodation case along the direction from the inside of the accommodation case toward the opening part.

11. The electrode assembly insertion guide according to claim 1, further comprising:
a groove part formed by recessing a surface facing the inside of the accommodation case among surfaces of the body part in a direction toward an outside of the accommodation case.

12. The electrode assembly insertion guide according to claim 11, wherein the groove part is extended along the direction from the inside of the accommodation case toward the opening part.

13. The electrode assembly insertion guide according to claim 11, wherein a plurality of the groove parts are provided.

14. The electrode assembly insertion guide according to claim 13, wherein the plurality of groove parts are located to be spaced apart from each other in a direction perpendicular to the direction from the inside of the accommodation case toward the opening part.

15. An electrode assembly inserting method using an electrode assembly insertion guide for guiding insertion of an electrode assembly into an accommodation case, the method comprising:
coupling a body part to an edge of an opening part formed by opening one surface of the accommodation case; and
inserting the electrode assembly into the accommodation case through the opening part.

16. The method according to claim 15, further comprising:
separating the body part coupled to the edge of the opening part from the accommodation case.
